(19) United States
(12) Patent Application Publication
(10) Pub. No.: US 2004/0226437 A1
(43) Pub. Date: Nov. 18, 2004

(54) Acoustical cavity for removal of contaminants from fluid

(76) Inventors: Eivind Stenersen, River Falls, WI (US); Richard Thomas Canepa, Plymouth, MN (US); Christopher Lee Conway, Shoreview, MN (US); Mark Alan Gogins, Roseville, MN (US)

Correspondence Address: Merchant & Gould P.C., P.O. Box 2903, Minneapolis, MN, 55402-0903, US

(21) Appl. No.: 10/817,241

(22) Filed: Apr. 2, 2004

Related U.S. Application Data
(60) Provisional application No. 60/460,844, filed on Apr. 4, 2003.

(51) Int. Cl. B01D 51/08

(52) U.S. Cl. 95/29; 96/389

(57) ABSTRACT

A system for particulate removal from fluid streams by using acoustic cavity technology. The technology can be applied to various applications, such as Diesel engine post-combustion emissions control systems, mist filtration systems, particle recovery systems, liquid degassing systems, and closed crankcase ventilation systems. An acoustic cavity can be used to replace an inertial separator, cyclone, or similar particulate removal equipment, providing a considerably lower pressure loss across the cavity compared to an inertial separator or cyclone, because an acoustic cavity does not appreciable alter the fluid flow path.

This application claims priority under 35 U.S.C. § 119(e) to U.S. provisional application serial No. 60/460,844, filed Apr. 4, 2003 and entitled “Acoustical Cavity for Filtering Contaminants”. The entire disclosure of 60/460,844 is incorporated herein by reference.

### FIELD OF THE INVENTION

The present invention is directed to removal of particulate matter from fluid streams. In particular, the invention is directed to removal of liquid and solid particulate matter from liquid or gas streams using an acoustic cavity.

### BACKGROUND

Particulate matter suspended in a fluid, such as air, is affected by a variety of forces. The net sum of these forces dictates how the particulate matter behaves in the fluid. For example, particles may settle due to the force of gravity or inertial forces, or remain suspended due to the effects of resistance and diffusion. The particulate matter may collect or deposit on surfaces due to thermophoresis or static charge. For sub-micrometer sized particulate matter, non-gravity forces are more significant than the force of gravity. These physical phenomena can be used to manipulate the presence of particulate matter to obtain certain desirable effects.

Filtration media are designed and constructed so that particulate matter is collected or trapped by the medium. A specific filtration media's ability to collect the desired particulate matter is a function of several physical characteristics that are designed into the filtration medium. One example of a physical characteristic is pore size of the media.

Inertial separators are frequently used for gas or liquid cleaning. In these devices, the fluid having the particulate matter is made to bend sharply. The higher density particles, which have difficulty making the sharp bend, are thrown to the outside of the bend, and so are concentrated in a portion of the fluid flow. The flow is then split into a clean and a dirty portion. Various cyclones, centrifuges, inertial separators, virtual impactors, and the like, are used for this purpose, often to reject undesired particles such as dirt from a fluid flow, but also to concentrate and collect desired particulates. In general, these devices work well to remove particulate, but they add undesirable restriction to the flow.

One physical phenomenon affecting suspended particulate matter is acoustic waves. It has been known for more than 200 years that dust tends to collect in certain locations in the pipes of pipe organs, such as those commonly found in churches and cathedrals. The particulate matter has a tendency to collect at the node of standing sound waves. Different size particles will also resonate at different amplitudes, causing a relative motion between the different size particles resulting in coagulation (i.e., ultrasonic coagulation).

It has been demonstrated in laboratories under controlled conditions that acoustic coagulation can be used to increase particle sizes as a mean of pretreatment upstream of barrier filters. Very few, if any, of such devices are used commercially. In 1993, the University of Minnesota attempted to design a Diesel soot-concentrating device. The device was designed with sub-woofer speakers to create an acoustic wave. The speakers were driven by a power supply/controller that was supposed to create a standing wave in an exhaust system of a Diesel engine. The device was never reduced to practice, as the study concluded that the power requirement for the device would be prohibitively high, in addition to other issues.

Los Alamos National Laboratory (LANL) has also studied acoustic cavity technology. The acoustic devices evaluated by LANL for concentrating particulate matter were based on traditional speaker technology or standing waves in pipes. The technology developed by LANL used the wall of a cylinder constructed from a piezo-electric material as the speaker. The piezo-electric material could be excited to create sound waves inside the cylinder, thus requiring only very low levels of power. A standing wave across the cross section of the cylinder was generated along the length of the cylinder. It was found for a fluid flowing through the cylinder, as long as the flow was laminar, any particulate matter entrained within the fluid was concentrated and coagulated at the node(s) of the generated sound wave(s). See U.S. Pat. Nos. 6,467,350 and 6,644,118.

This technology was developed to aid the detection of anthrax spores in air ducts, which may be present due to an act of terrorism. Even minute concentrations of anthrax spores suspended in an air stream flowing through this device would migrate to the node of the acoustic wave. With this technology, an anthrax sensor that normally would not be able to detect very low concentrations of anthrax would now be able to make a positive detection as even just one spore will migrate to the node(s) of the sound wave(s).

Although this technology has been attempted for aerosol sampling purposes, for example for the detection of anthrax spores, the technology has not progressed to a point where it would be feasible for use in providing clean air, gasses, or other fluids. What is desired is an advance in acoustic technology for particulate removal from fluid.

### SUMMARY OF THE INVENTION

The present invention provides particulate removal from fluid streams by using acoustic cavity technology. The technology can be applied to various applications that currently use particulate filtration devices; applications such as engine post-combustion emissions control systems (both compression ignition (i.e., Diesel) and spark ignition engines), mist filtration systems, particle recovery systems, liquid degassing systems, and closed crankcase ventilation systems. Typically, an acoustic cavity can be used to replace an inertial separator, cyclone, or similar particulate removal equipment, providing a considerably lower pressure loss across the cavity compared to an inertial separator or cyclone, because an acoustic cavity does not appreciable alter the fluid flow path.

In one aspect of this invention, methods for removing particulate matter from a fluid stream are provided. The methods include providing a gas stream having an inlet plurality of particles having an inlet particle size therein, and passing the gas stream through an acoustic cavity system configured for having energy waves therein. The acoustic cavity system may have more than one acoustic cavity, which could be positioned in parallel or series. Provided is an outlet stream having an outlet plurality of particles having an outlet particle size therein, the outlet particle size being greater than the inlet particle size and the outlet plurality of particles being less than the inlet plurality of particles. This outlet stream may be passed through a particulate removal system to collect the outlet particles; examples of such systems include barrier filters such as pleated media.

The fluid stream may be a liquid stream or a gas or gaseous stream. Air is an example of a common gas. The particles in the fluid stream can be solid or liquid, or a combination thereof. An aerosol is an example of fine particles suspended in a gaseous stream. A mist is an example of fine particles suspended in a gaseous stream, where at least half the total mass of particles is liquid. By use of the term “particulate”, “particulate matter”, “particles” and variations thereof, what is intended is material that is either solid or liquid. The fluid stream may be at atmospheric or ambient pressure, or at an elevated or reduced pressure.

In another aspect of the invention, the method can include separating the gas stream into a concentrated stream and a cleaned stream, the concentrated stream comprising the outlet plurality of particles. This step of separating the gas stream can be done within the acoustic cavity system or downstream of the acoustic cavity system. Either of the streams, but typically the concentrated stream, can be passed through a particulate removal system to collect particles.

The invention is particularly suitable for removing exhaust particulate (e.g., soot) from an exhaust stream from an engine, such as a compression ignition engine or a spark ignition engine. Such a method can comprise providing an exhaust stream from an engine, the exhaust stream having an inlet plurality of particles having an inlet particle size therein; and passing the exhaust stream through an acoustic cavity system configured for having energy waves therein to provide an outlet stream having an outlet plurality of particles having an outlet particle size therein, the outlet particle size being greater than the inlet particle size and the outlet plurality of particles being less than the inlet plurality of particles.

An exhaust system for an engine can be designed utilizing the acoustic cavity system of the invention. Such an exhaust system can have an engine exhaust conduit extending from the engine, an acoustic cavity system configured for having energy waves therein, the acoustic cavity system having an inlet connected to the engine exhaust conduit and an outlet, and an exhaust outlet operably connected to the cavity outlet. The exhaust system could include a NOx reduction device and/or a particulate removal system, such as a particle trap.

The invention is also particularly suitable for use with a closed crankcase ventilation system for a compression ignition engine or a spark ignition engine.

### BRIEF DESCRIPTION OF THE DRAWINGS

FIG. 1 is a schematic diagram of a Diesel engine exhaust system incorporating an acoustic cavity for particulate removal from the exhaust stream.

FIG. 2 is a schematic diagram of a second Diesel engine exhaust system incorporating an acoustic cavity for particulate removal from the exhaust stream.

FIG. 3 is a schematic diagram of a system incorporating an acoustic cavity together with a filter media for particulate removal from a fluid stream.

FIG. 4 is a schematic diagram of a system incorporating an acoustic cavity together with an inertial separator for particulate removal from a fluid stream.

FIG. 5 is a schematic diagram of a closed crankcase system incorporating an acoustic cavity.

### DETAILED DESCRIPTION

As briefly described above, the present invention provides particulate removal from fluid streams by using acoustic cavity technology. A cavity is provided, through which a fluid stream having particulate contaminants flows. A standing energy wave is provided in the cavity by a power supply; typically the energy waves are sound waves. The particles are suspended by the energy waves, causing the particles to remain entrained in the fluid and the energy waves. The particles gravitate to the point(s) of least excitement, which are the node(s) of the energy waves.

The acoustic cavity is generally a cylindrical or annular cavity sized so that an integral number of half waves, typically sound waves, extend across and resonate within the cavity. The acoustic cavity is designed so that the dimensions of the cavity and the frequency of the sound waves, together, provide at least one location in the cavity where particulate can be concentrated and collected. At least a portion of the cavity is made from a piezo-electric material, typically a piezoceramic tube (PZT) designed to create and resonate energy waves from a small amount of inputted electrical energy. Piezoceramic tubes are often made from lead zirconate titanate. PZT material can be obtained commercially from Boston Piezo-Optics Inc. 38 B Maple Street Bellingham, Mass. 02019 USA. Additional details regarding design and construction of acoustic cavities can be found in U.S. Pat. Nos. 6,467,350 and 6,644,118, both which are incorporated herein by reference in their entirety.

The particulate matter in the fluid stream concentrates at the node(s) of the waves of the acoustic cavity. A fraction of the overall fluid stream, that having the concentrated particulate matter, is separated from the overall fluid flow. This concentrated particulate flow exits the acoustic cavity separate from the remainder of the fluid. The concentrated particulate flow can be further treated, such as by a barrier filter.

The acoustic cavity may be positioned for operation in a vertical position or in a horizontal position. By use of the term “vertical position” and variations thereof, what is intended is a configuration having the fluid stream entering and/or exiting the cavity in a generally vertical configuration. The inlet may be above or below the outlet of the cavity. By use of the term “horizontal position” and variations thereof, what is intended is a configuration having the fluid stream entering and/or exiting the cavity in a generally horizontal, although not necessarily level, configuration. It is understood that acoustic cavities may have a fluid path therethrough that is a combination of vertical and horizontal positioning.

The use of acoustic cavity technology can be applied to various applications that separate and remove particles or particulate from fluid in order to provide a cleaned fluid; examples of such applications include Diesel engine (i.e., compression ignition) and spark ignition post-combustion emissions control systems, particle removal systems in gasses or liquids, mist filtration systems, particle recovery systems, liquid degassing systems, closed crankcase ventilation systems, and other applications that typically use a barrier filter to provide a cleaned fluid stream.

Diesel Engine Post-Combustion Emissions Control Systems

Although Diesel engines benefit from having the highest thermal efficiency of all thermodynamic cyclic heat engines, Diesel engines produce significant amounts of harmful pollutants. Diesel engines operate with an overall lean fuel/air mixture such that 3-way catalytic converters, standard with spark ignition engines, do not work in a 3-way mode. For example, reduction of NOX emissions is non-existent from a catalytic converter positioned on a Diesel engine. In addition, during operation of a Diesel engine, significant amounts of particulate matter are produced during the combustion process. The nature of Diesel engine combustion is such that there is an inverse relationship between particulate matter and NOX; an engine can be tuned to produce less NOX at the expense of higher soot production, and vice versa.

To remove the particulate matter, particle traps, designed to handle the full flow rate from Diesel engines, are used. The exhaust flow rate in a typical class-8 truck engine is about 3000 ACFM at rated power and speed. The particle traps are usually designed to be installed two in parallel such that one can be regenerated while the other is in ‘collection mode’. Exhaust particle traps are very large and heavy, to ensure reasonable backpressure for the engine. Due to the inherent large thermal mass of the traditional particle traps, several kilowatts of electric power or additional fuel injected into the exhaust stream are needed for regeneration.

By using an acoustic cavity for particulate removal, the size, weight of the exhaust system for a Diesel engine is greatly reduced. The system also requires far less power for regeneration.

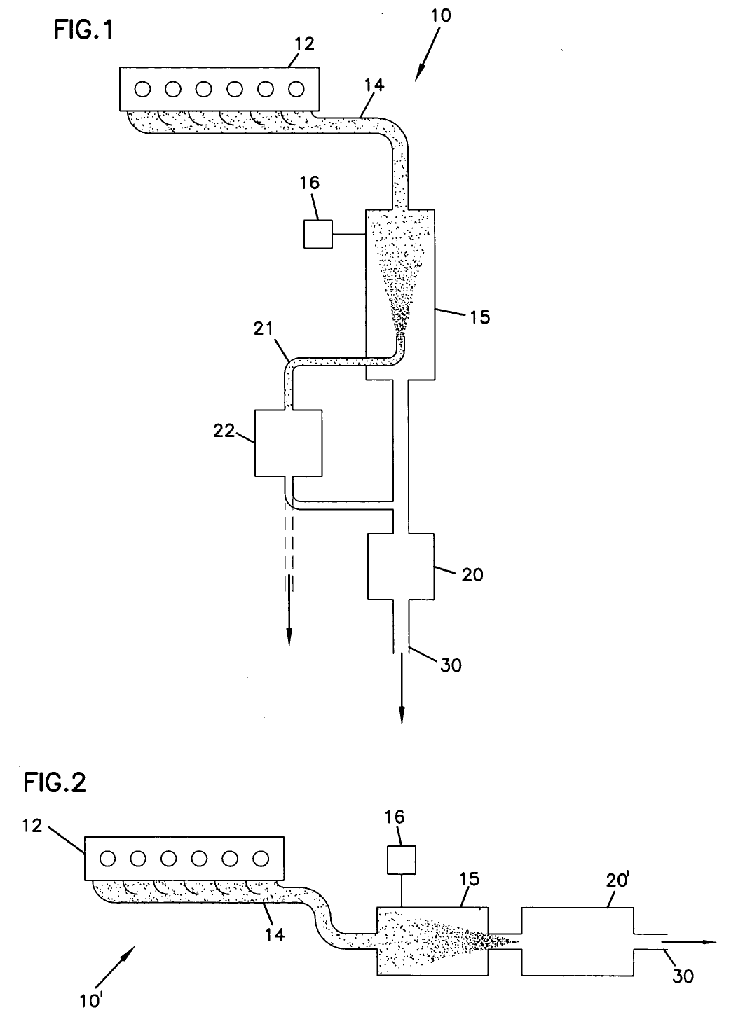

Attention is directed to FIG. 1, where an exhaust system 10 for a Diesel engine is schematically illustrated. Diesel engine 12 has an exhaust conduit or stack 14 that transports the exhaust from engine 12. The exhaust includes levels of NOX and particulate contaminants, such as soot. From Diesel engine 12, the exhaust, via conduit 14, enters an acoustic cavity system 15. Acoustic cavity system 15 may be several acoustic cavities or one large acoustic cavity, all which would be sized for the flow rate of exhaust. Multiple cavities may be positioned in parallel, so that the exhaust stream is split between the multiple cavities, or, multiple cavities may be positioned in series. Individual cavities, when present as one of multiple cavities, may be tuned to separate different sizes of particulate. Although acoustic cavity 15 is illustrated positioned in a vertical configuration, with its inlet positioned above its outlet, cavity 15 may be configured horizontally.

Acoustic cavity 15 concentrates the particulate matter in the exhaust gas to a specific region in cavity 15. A power supply and control module 16, operably connected to cavity 15, produces wave energy, typically sound waves, that resonate within cavity 15. Cavity 15 is generally a cylindrical or annular cavity sized so that an integral number of half waves, typically sound waves, extend across and resonate within the cavity. Additional details regarding design and construction of cavity 15 can be found in U.S. Pat. Nos. 6,467,350 and 6,644,118, both which are incorporated herein by reference. The particulate matter concentrates at the node(s) of the waves. A fraction of the overall flow, where the particulate matter is concentrated, is separated from the overall exhaust flow. This concentrated particulate flow exits acoustic cavity 15 via conduit 21 and is directed into a filtration device 22. Filtration device 22 could be a regenerative particle trap, a pulse jet exhaust filter, or other particulate or soot removal system.

The larger portion of the exhaust flow from acoustic cavity 15 is essentially free from particulate matter. This stream can flow into an NOX reduction device 20 before being exhausted to the atmosphere via outlet 30.

The former-particulate stream, now having the particulate removed by filtration device 22, can be rejoined with the larger portion of the exhaust flow and passed through NOX reduction device 20. Alternately, the stream could be exhausted directly into the atmosphere.

The particle size distribution of the particulate in the concentrated stream differs from the size distribution of the inlet stream due to a coagulation effect in acoustic cavity 15. The particles exiting cavity 15 via conduit 21 are larger and fewer in number compared to those entering cavity 15 via conduit 14; this is due to particles agglomerating or coagulating together within acoustic cavity 15, caused in part by the high temperature of the particles and their physical characteristics. The particles may alternately or additional be held together by interparticle forces such as magnetic forces, electrostatic forces, Van der Waal's forces, and other physical or chemical interparticle forces.

Prior to entering filtration device 22, the concentrated particulate stream may be cooled, for example by a heat exchanger. The combination of a lower temperature and larger particles allow use of a traditional type of filter. Depending on the filter used, the used filter could be incinerated or otherwise disposed. Additionally or alternately, the filter could be cleaned by a pulse-jet cleaning process, and the removed particulate matter disposed. A pulse-jet cleaned system will especially benefit from the coagulation effect in the acoustic cavity as larger particles are more likely to surface load on a filtration media.

In an alternate configuration of system 10, the coagulation effect of the acoustic cavity can be utilized and but the particulate matter not separated from the exhaust stream. A schematic of such a system is shown in FIG. 2. In FIG. 2, system 10′ includes a Diesel engine 12 and an exhaust conduit 14 which transports the exhaust from engine 12 to acoustic cavity system 15. Acoustic cavity system 15 may be several acoustic cavities or one large acoustic cavity, all which would be sized for the flow rate of exhaust. Cavity 15 agglomerates or coagulates the particles, decreasing the number of individual particles and increasing the particle size distribution. Cavity 15 is illustrated positioned in a horizontal position, with its inlet generally level with its outlet; cavity 15 could be configured to be positioned vertically.

Acoustic cavity 15 concentrates the particulate matter in the exhaust gas to a specific region in cavity 15. A power supply and control module 16 produces wave energy, typically sound waves, that resonate within cavity 15. In system 10′, the particulate matter is not separated out at cavity 15, but rather, the entire stream exiting cavity 15 is fed to a contaminate removal system 20′, which removes both particulates and reduces NOx.

Because the exhaust has fewer but larger particles exiting acoustic cavity 15 compared to the exhaust flowing into the acoustic cavity, contaminate removal system 20′ can utilize a soot removal system, such as particle traps or barrier filters, that is smaller in size and has larger pores than those conventionally used. Such smaller systems have a lower flow restriction and thus less power is needed for their regeneration.

Other Enhanced Filtration Systems for Gases and Liquids

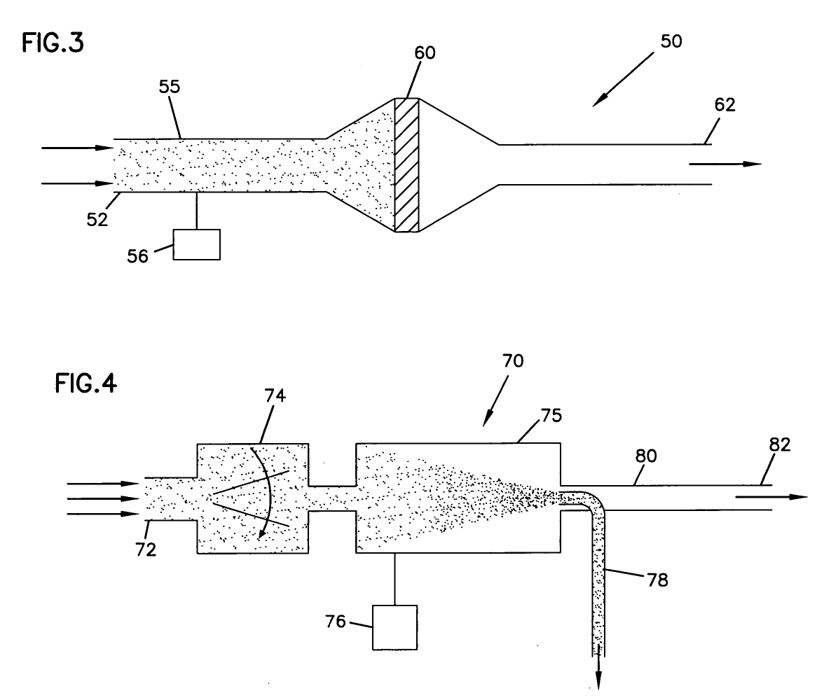

As discussed above, acoustic cavities alter particles sizes and can be used in virtually any application where a barrier filter is used. Additionally, an acoustic cavity can be used as a prefilter, upstream of a filter, as described in relation to system 10′ of FIG. 2. Fewer but larger particles exit the acoustic cavity compared to the particles flowing into the cavity. FIG. 3 is another embodiment where an acoustic cavity is used up-stream of a filter, particularly, a barrier type filter or membrane. This embodiment is well suited for gas (including air) or liquid purification.

In FIG. 3, a system 50 is illustrated, the system having an inlet 52 for receiving a flow a dirty fluid, such as a gas or liquid. The fluid stream enters an acoustic cavity 55, to which is operably connected a power supply control module 56. Acoustic cavity 55 may be several acoustic cavities or one large acoustic cavity, all which would be sized for the flow rate through system 50. Multiple cavities may be positioned in parallel, so that the incoming contaminated stream is split between the multiple cavities, or, multiple cavities may be positioned in series. Downstream of acoustic cavity 55 is a particulate filter 60. The fluid, downstream of filter 60 and removed of particulate matter, exits via outlet 62 as cleaned fluid.

Due to the agglomeration or coagulation effect of acoustic cavity 55, the average size of the particles retained on filter 60 is greater than the average size of the particles at inlet 52, and, the number of particles retained on filter 60 is less than the number entering via inlet 52.

Filter 60 generally can be any suitable particulate filter. Typically, filter 60 contains a filter media, such as a fibrous mat or web, including cellulosic materials, to remove particles. In certain preferred arrangements, filter 60 is configured for straight-through flow. By “straight-through flow,” it is meant that filter 60 is configured so as to have a first flow face (corresponding to an inlet end) and an opposite, second flow face (corresponding to an outlet end). Air enters in one direction through the first flow face and exits in the same direction from the second flow face. It is intended that there is no distinction between “straight-through flow” and “in-line flow”.

The filter media can be treated in any number of ways to improve its efficiency in removing minute particulates; for example, electrostatically treated media can be used, as can cellulose or synthetic media or a combination thereof, having one or more layers of fine fiber, or other types of media known to those skilled in the art. For details regarding types of fine fiber that could be used, see for example, U.S. Pat. No. 4,650,506 (Barris et al.), which is incorporated herein by reference. A filter having straight-through flow with fine fiber that can be used is described in U.S. Pat. No. 6,673,136 (Gillingham et al.), which is also incorporated herein by reference.

Filter 60 may include a series of filter media or constructions, or, a single media or construction can be used.

Filters and filtrations systems have a tradeoff between filtration efficiency, capacity of captured dirt (filter life) and pressure drop across the filter. HEPA filters, which are common in today's market, are specified to have 99.97% trapping efficiency for 300 nano-meter particles. It is well known in the filtration art that the most difficult particles to trap are 300 nano-meter particles. In order to obtained the required filtration efficiency, HEPA filtration media is usually highly flow restrictive and has limited retention capacity.

Inclusion of an acoustic cavity improves the operation of HEPA filtration systems. The acoustic cavity coagulates the particles, thus allowing a more open barrier filter that meets the required standards yet has lower restriction and higher capacity compared to traditional systems not using an acoustic cavity. A more open filter has a lower pressure or restriction across it.

Increasing the size of the particles will also reduce the pressure drop due to the dust cake loaded onto the filter; for equal mass loading of particles, the dust cake with smaller particles has a higher pressure drop. In this way, use of an acoustic cavity to agglomerate or coagulate the particulate up-stream of a filter increases the dust loading before reaching terminal pressure drop.

Having larger particles also improves the cleaning ability of the filter. Pulse-jet systems and reverse-pulse systems use a pulse of air or other gas to knock the dust off the filter. These pulse systems perform better when larger dust is present, as the larger particles more easily detach from the filter media. Some cleaning systems shake or vibrate the filter media to remove the dust; these systems also perform better when larger dust is present.

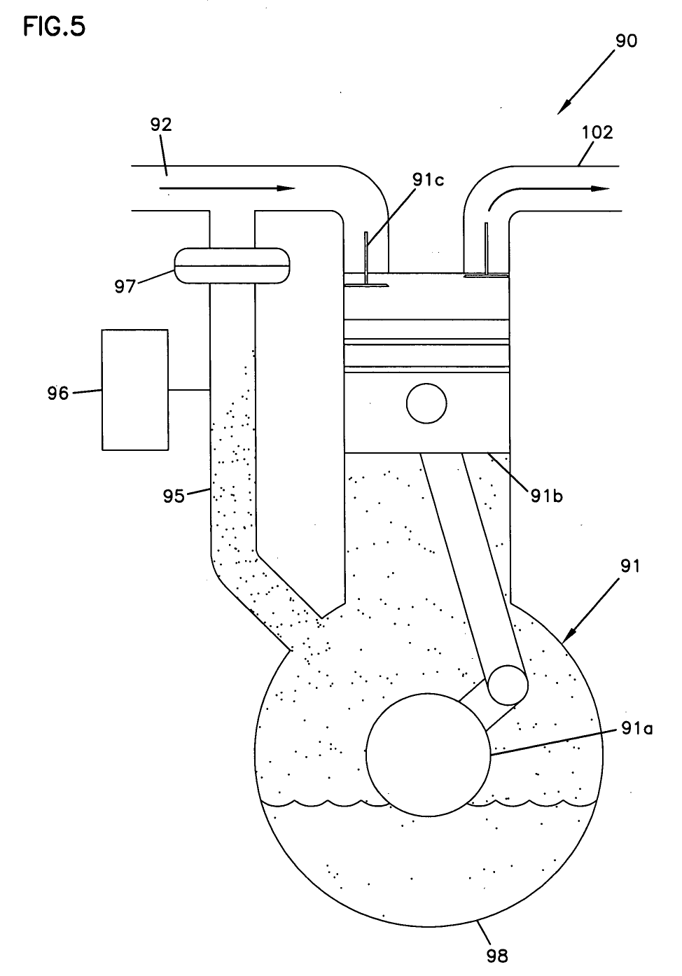

An embodiment of a barrier-less filtration system that can be achieved with an acoustic cavity is illustrated in FIG. 4. By use of the term “barrier-less”, what is meant is a particle removal system that does not include a screen, filter media, membrane, or the like, through which all of the flow passes. System 70 of FIG. 4 has an inlet 72 for receiving a flow of dirty fluid, such as a gas or liquid. The fluid stream enters an inertial separator, cyclone, or other similar equipment 74 that removes large particles from the fluid stream. From separator 74, the fluid stream progresses to acoustic cavity 75, to which is operably connected a power supply control module 76. Acoustic cavity 75 concentrate particulate matter, by agglomerating or coagulating multiple smaller particles into larger particles. The small portion of the flow, where the particulate matter is concentrated and agglomerated by cavity 75, is removed via tube 78. The larger volume of the flow, now free from particulate matter, progress via conduit 80 to outlet 82.

Although illustrated in FIG. 4, inertial separator 74 is not needed for all embodiments, but is generally used in very high dust conditions or when a portion of the particles is relatively larger than the others.

Examples of applications where an acoustic cavity system can be used to replace a barrier filter for particle removal is on the air intake side of power generating equipment such as engines, fuel cells, compressors, and the like.

Particle Recovery System

Similar to the description of the barrier-less filtration system of FIG. 4, above, an acoustic cavity can be used to concentrate particulate matter in a duct. After being concentrated, the particulate matter can be collected and retained for further processing. Such an assembly is useful when the particulate material is valuable or material reclamation is otherwise desired. A barrier filter could be used to collect the concentrated particulate matter.

Liquid Degassing System

As described, an acoustic cavity system separates materials based on mass, density and particle size. An acoustic cavity can be used to concentrate and then separate finely dispersed gas bubbles that occur in many fluids, particularly in liquids. Conventionally, various inertial separators and filtration type devices, many of them barrier filters, are used to degas water and other fluids. An acoustic cavity, to concentrate and increase the size of the gas bubbles, would be able to accomplish the same or better performance at a lower pressure drop.

Mist Filtration System

An acoustic cavity or cavity system can also be used for applications where separation of an aerosol mist from gas is desired. A mist has at least 50% by mass of the aerosol particles being liquid. Conventionally, liquid aerosol mists are commonly removed from air or other gas by inertial separators and/or media filters such as barrier filters. An example of a barrier filter for collection of oil from a compressor is disclosed in U.S. Pat. No. 6,485,535. Typically, the mist is directed against an impact surface of an apparatus, typically fibrous media, where the liquid builds up and then drains away. A common term for the fibrous media filter used for such applications is “coalescing filter” and variations thereof.

In accordance with the present invention, an acoustic cavity can be used to coalesce and remove mists from gases, such as air. Concentration or other agglomeration of the liquid mist using an acoustic cavity provides a less restrictive mist collection device due to the larger mist particle size. A closed crankcase ventilation system is an application where an acoustic cavity is highly beneficial. Other applications include machining, grinding, polishing, and other applications where a mist is created, for example, by coolant, lubricant or cutting fluid.

Closed Crankcase Ventilation System

Various internal combustion engines, typically those that have to meet strict emissions standards, utilize a closed crankcase ventilation system to prevent engine crankcase gases and particles from entering and polluting the atmosphere. The crankcase gases consist of mostly air; small amounts of combustion products that escape past the piston rings during the engine's expansion strokes, and lubrication oil particles and droplets, may be suspended in the escaping gas. Donaldson Company, in partnership with the University of Minnesota, has characterized crankcase gases for heavy-duty truck Diesel engines and typical flow rates. The crankcase gas flow-rate through the ventilation system depends on engine speed and load and will typically be from 4 to 16 ACFM for class 8 truck engines. The flow rate will be higher for highly worn engines. The particles suspended in the crank case gases consist of oil droplets and soot. The particle sizes distribution vary with engine operating conditions, but all of the particles are below 14 μm in all conditions. 70% of the particles by mass are typically below 3μm and 60% by mass below 1μm.

One example of a closed crankcase ventilation system is described in U.S. Pat. No. 6,187,073, and specific embodiments of barrier filters are disclosed in U.S. Des. Pat. Nos. 410,010, 420,117 and 439,962; this technology is proprietary to Donaldson Company Inc. and is commonly referred to as SPIRACLETM. The Donaldson Spiracle systems and other similar traditional systems for cleaning crankcase gases rely on various mediums to coalesce the particles. Conventionally, interference or barrier filtration is used to coalesce, if needed, and remove the particles from the gas stream.

In accord with the present invention, an acoustic cavity system can be added to coalesce, coagulate or agglomerate the aerosol or mist lubricant particles and direct them to a recirculation loop. Such as system would minimize the need for any interference or barrier media filter design. Additionally, an acoustic cavity would be able to easily utilize power source of the engine and potentially include some sensors or diagnostics as part of the re-circulating loop.

Referring to FIG. 5, a closed crankcase ventilation system 90 is schematically illustrated. System 90 includes a crankcase system 91 which includes a crankshaft 91a connected to a piston 91b having an intake valve 91c. An oil reservoir 98 lubricates crankshaft 91 a and other features of crankcase 91. Air is brought into crankcase 91 via inlet 92 and exits via exhaust 102. A recirculation loop 95, which includes an acoustic cavity section connected to a power supply and controller 96, is provided. A pressure regulator 97 may be provided in loop 95. In use, pressure builds within oil reservoir 98, which requires venting, which occurs via recirculation loop 95. Oil mist particles present in the venting air are coalesced on the sides of the acoustic cavity by standing waves in the cavity; preferably, a node of the standing wave is present at or close to a wall of the cavity. The oil droplets, collecting on the wall, drain back into reservoir 98. A conventional barrier filter could be included downstream of the acoustic cavity (in FIG. 5, positioned above where the oil droplets collect on the wall) to increase the mist removal level.

The above description has provided various specific and preferred embodiments and techniques in accordance with the invention. It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size and arrangement of parts and types of materials within the principles of the disclosure to the full extent indicated by the broad general meaning of the terms in which the appended claims are expressed.

What is claimed:

1. A method of removing particulate from a gas stream, the method comprising:
(a) providing a gas stream having an inlet plurality of particles having an inlet particle size therein; and
(b) passing the gas stream through an acoustic cavity system configured for having energy waves therein to provide an outlet stream having an outlet plurality of particles having an outlet particle size therein, the outlet particle size being greater than the inlet particle size and the outlet plurality of particles being less than the inlet plurality of particles.

2. The method according to claim 1 further comprising:
(a) separating the gas stream into a concentrated stream and a cleaned stream, the concentrated stream comprising the outlet plurality of particles.

3. The method according to claim 2, wherein the step of separating the gas stream is done within the acoustic cavity system.

4. The method according to claim 2, wherein the step of separating the gas stream is done downstream of the acoustic cavity system.

5. The method according to claim 2 further comprising:
(a) passing the concentrated stream through a particulate removal system to collect the outlet plurality of particles.

6. The method according to claim 1 further comprising:
(a) passing the outlet stream having an outlet plurality of particles through a particulate removal system to collect the outlet plurality of particles.

7. The method according to claim 1, wherein the gas stream is an air stream.

8. The method according to claim 7, wherein the inlet plurality of particles comprises liquid particles.

9. The method according to claim 8, wherein the inlet plurality of particles comprise mist particles.

10. The method according to claim 7, wherein the air stream is an intake stream for an engine.

11. The method according to claim 1, wherein the step of passing the gas stream through an acoustic cavity system comprises passing the gas stream through at least two acoustic cavities.

12. The method according to claim 11, wherein the at least two acoustic cavities are in parallel.

13. A method of removing particulate from an exhaust stream, the method comprising:
(a) providing an exhaust stream from an engine, the exhaust stream having an inlet plurality of particles having an inlet particle size therein; and
(b) passing the exhaust stream through an acoustic cavity system configured for having energy waves therein to provide an outlet stream having an outlet plurality of particles having an outlet particle size therein, the outlet particle size being greater than the inlet particle size and the outlet plurality of particles being less than the inlet plurality of particles.

14. The method according to claim 13 further comprising:
(a) after passing the exhaust stream through the acoustic cavity system, separating the exhaust stream into a concentrated stream and a cleaned stream, the concentrated stream comprising the outlet plurality of particles.

15. The method according to claim 14 further comprising:
(a) passing the concentrated stream through a particulate removal system to collect the outlet plurality of particles.

16. An exhaust system for an engine, the system comprising:
(a) an engine exhaust conduit extending from the engine;
(b) an acoustic cavity system configured for having energy waves therein, the acoustic cavity system having an inlet connected to the engine exhaust conduit and an outlet; and
(c) an exhaust outlet operably connected to the cavity outlet.

17. The system according to claim 16 further comprising a NOx reduction device.

18. The system according to claim 16 further comprising a particulate removal system positioned between the cavity outlet and the exhaust outlet.

19. The system according to claim 18, wherein the particulate removal system comprises a particle trap.

20. The system according to claim 18, wherein the particulate removal system comprises a particulate filter comprising media.

21. The system according to claim 16, wherein the acoustic cavity system comprises at least two acoustic cavities.

22. The system according to claim 21, wherein the at least two acoustic cavities are in parallel.
